(19) United States
(12) Patent Application Publication
(10) Pub. No.: US 2009/0094529 A1
(43) Pub. Date: Apr. 9, 2009

(54) METHODS AND SYSTEMS FOR CONTEXT SENSITIVE WORKFLOW MANAGEMENT IN CLINICAL INFORMATION SYSTEMS

(75) Inventors: David Gerard Gonzalez, Beaverton, OR (US); Steven Lawrence Fors, Chicago, IL (US); Mark M. Morita, Arlington Heights, IL (US); William Douglas Hughes, Bainbridge Island, WA (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/869,465

(22) Filed: Oct. 9, 2007

(51) Int. Cl. G06F 3/048

(52) U.S. Cl. 715/751; 715/810

(57) ABSTRACT

Certain embodiments of the present invention provide methods and systems for execution of clinical workflows via a clinical application system. Certain embodiments provide a clinical application system facilitating completion of clinical workflow tasks. The system includes a processor configured to associate tasks in a clinical workflow with external actors. The system also includes a user interface displaying clinical information to a user. The tasks are represented as links in the user interface. Each of the links triggers access to a corresponding external actor. Selection of at least one of the task links via the user interface triggers at least one of execution of and access to at least one of the external actors.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to aggregating and viewing patient data. More particularly, the present invention relates to methods and systems providing clinical display and search capabilities for all of a patient's electronic medical record data from a variety of disparate information systems.

Healthcare has become increasingly centered around electronic data and records management. Healthcare environments, such as hospitals or clinics, include information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access patient information or other information at various points in a healthcare workflow.

Robust clinical information system software applications typically support clinical users performing a wide range of workflows and interacting with significant volumes of clinical information. In a conventional clinical application, a single workflow (such as discharging a patient from an emergency room) might involve a user executing multiple tasks. Execution of multiple tasks often requires the user to navigate to several different parts of the application in order to perform each step of that workflow. Navigating through such complex software systems can be challenging if the user is unsure where to go within the application to perform the specific task. Such navigation can also be tedious, as the system may require the user to perform several actions (e.g., mouse clicks) to get the application properly configured to perform the task. Finally, for many clinical workflows, there may be more than one clinical user performing tasks that relate to the specific workflow. It can be difficult for multiple users to visualize which tasks have been completed already, and which ones remain to effectively coordinate their efforts.

Existing clinical information systems have incorporated features that try to improve usability of these complex systems. To-do lists, clinical decision support, and workflow engines have been implemented to help automate some of the work that needs to be accomplished during the execution of complex workflows. No product, to date, has combined these features into a user-centric workflow management system.

### BRIEF SUMMARY OF THE INVENTION

Certain embodiments of the present invention provide methods and systems for execution of clinical workflows via a clinical application system.

Certain embodiments provide a clinical application system facilitating completion of clinical workflow tasks. The system includes a processor configured to associate tasks in a clinical workflow with external actors. The system also includes a user interface displaying clinical information to a user. The tasks are represented as links in the user interface. Each of the links triggers access to a corresponding external actor. Selection of at least one of the task links via the user interface triggers at least one of execution of and access to at least one of the external actors.

Certain embodiments provide a method for workflow task execution via a clinical application interface. The method includes associating tasks in a clinical workflow with external actors. The tasks are represented as links in the clinical application interface. Each of the links triggers access to a corresponding external actor. The method also includes displaying the task links to a user via the clinical application interface. Additionally, the method includes triggering at least one of execution of and access to at least one of the external actors through selection of at least one of the task links via the clinical application interface.

Certain embodiments provide a computer readable medium having a set of instructions for execution on a computer. The set of instructions includes a workflow processing routine configured to associate tasks in a clinical workflow with external actors. The set of instructions also includes a user interface routine displaying clinical information to a user. The tasks are represented as links in the user interface. Each of the links triggers access to a corresponding external actor. Selection of at least one of the task links via the user interface triggers at least one of execution of and access to at least one of the external actors.

### BRIEF DESCRIPTION OF SEVERAL VIEWS OF THE DRAWINGS

FIG. 1 illustrates an exemplary user interface showing task links to facilitate user workflow in accordance with an embodiment of the present invention.

FIG. 2 illustrates a system for clinical data storage and retrieval in accordance with an embodiment of the present invention.

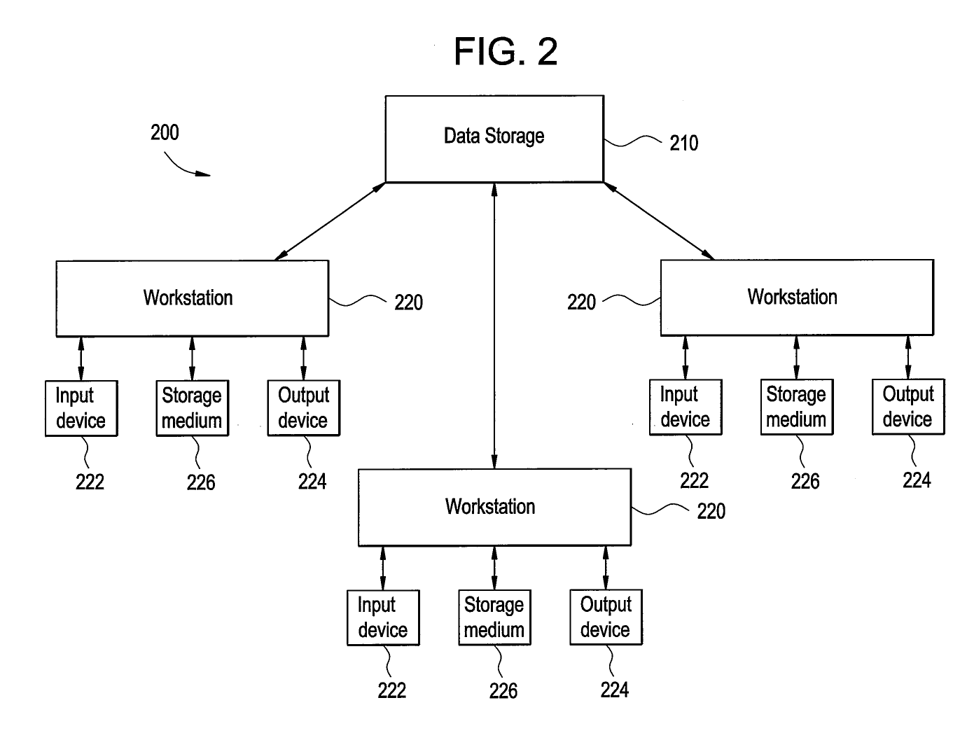

FIG. 3 illustrates a flow diagram for a method for providing a workflow task list and other information for selection by a user via a user interface in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide systems and methods facilitating full clinical display and search of a patient's electronic medical record data from a variety of disparate information systems. In certain embodiments, a worklist or browser queries one or more enterprise hospital information systems. The worklist or browser aggregates the queried data into a single, interactive window that displays information, tasks, workflow execution steps, and/or other information from a particular patient and/or action search.

In certain embodiments, the worklist/browser can display information from systems such as Radiology, Cardiology, Pharmacy, Medication, and Lab information systems as well as Picture Archiving and Communication systems and/or other clinical information systems. Current systems do not allow flexibility and breadth in connected and queried information systems.

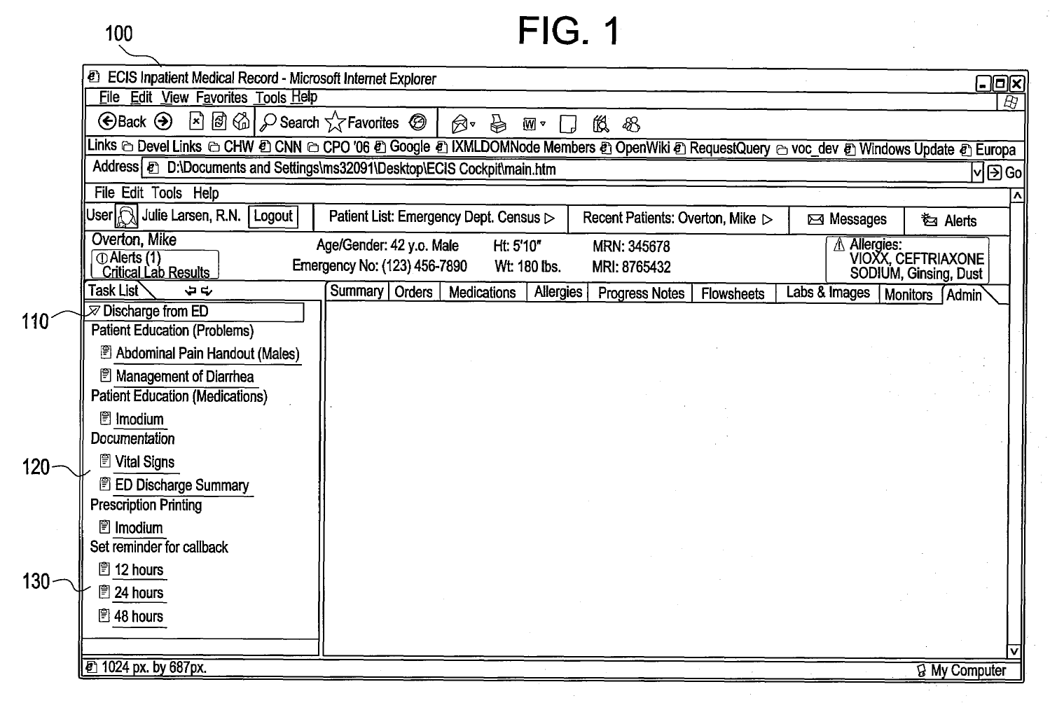

Certain embodiments present a user interface, such as the user interface shown in FIG. 1, that integrates context-sensitive links pointing to areas of an application or workflow to which a user is likely to navigate. The system is aware of the user's current workflow (e.g., ‘discharge patient from Emergency Room’). The system is also aware of actions that may and/or may not need to be done and/or might be done for the patient. Furthermore, the system is aware of actions that the user may want (and/or need) to do for a patient population in which he/she is working. Links or indicators present in the user interface serve as shortcuts (or ‘hyperlinks’). When selected by the user, a link allows the user to open and/or access a specific functionality within the application or workflow that supports performing the selected task. When the user is finished with one task, another shortcut may then be selected from the list, helping the user execute a series of steps required for the given workflow.

For example, an emergency department (ED) nurse may be looking at a high level ‘white board’ summary view of all patients in the ED. The white board display shows that one of the nurse's patients is ready to be discharged. Once the nurse clicks on the discharge status indicator, a clinical application driving the white board recognizes that there is a “discharge patient from ED” workflow available. In response, a shortcut panel interface (such as that shown in FIG. 1) appears which presents the user with several links to those areas of the clinical application (or applications) that the nurse is likely going to use to discharge the patient. In this example, the nurse may be shown links to patient handout materials that relate to the admitting diagnoses for this patient. If there are medication prescriptions that need to be or should be provided to the patient, links may appear that allow the nurse to print those prescriptions out for the patient and/or otherwise transmit them for disbursement to the patient.

Other steps that are routinely performed for patients with relevant presenting problems may also appear via the interface. For example, one or more links that facilitate generation of a callback reminder may be shown. Later, the nurse may wish to order a dose of digoxin and/or other medication for a patient. Because that medication can cause problems if the patient has a low potassium level, the user interface presents the user with options to view previous potassium levels, order a potassium level, and/or order a serum digoxin level, for example.

In certain embodiments, a list or lists of shortcuts appearing in the user interface may not necessarily serve as a conventional ‘task list’ in that the user may not need to, or wish to, execute each of the tasks on the list. The user interface may render a task shortcut differently, however, if the task is already completed, to give the user a better sense of which tasks in the workflow are completed and which are left undone, for example.

One or more lists of shortcuts, or potential tasks, may be defmed within a clinical system as a series of ‘rules’. These rules can be authored and/or edited by clinical content creators at a software provider and/or at a customer site, for example. Execution of these rules is triggered by user events from within a clinical application as well as by changes to a clinical record itself, for example.

FIG. 1 illustrates an exemplary user interface 100 showing task links to facilitate user workflow in accordance with an embodiment of the present invention. As shown in FIG. 1, a user, such as a nurse (e.g., Julie Larsen as indicated on the interface 100 of FIG. 1), can click on or otherwise select a “discharge” status indicator for a patient (e.g., Mike Overton) on an ED whiteboard screen to be taken to an interface 100 showing the patient's chart. The patient chart interface 100 includes a workflow management list window 110, shown here in an exemplary position on the left, for example. The task list 110 provides links to various places in one or more clinical applications that the user is likely to want and/or need to visit to discharge the patient and/or perform related actions, for example.

The task list 110 may be subdivided, for example, to reflect tasks involved in a particular workflow, such as a patient discharge workflow. As illustrated, for example, in FIG. 1, categories 120 such as patient education (problems), patient education (medications), documentation, prescription printing, and set reminder for callback may be used to group links for a user under a particular workflow. Within each category 120, links 130 are provided to guide the user through execution of tasks in a workflow. Looking at the interface 100 and task list 110 in FIG. 1, a patient discharge workflow is broken up into a plurality of categories 120 each having one or more tasks 130 that may or must be executed in order to complete the patient discharge.

By selecting a link 130, an appropriate action is taken for the user. For example, a nurse may select links 130 to provide prescription orders and/or information regarding Imodium, for example. The nurse may select other links 130 to obtain and/or generate vitals signs information, generate a discharge summary, and/or set a certain time reminder for a callback, for example.

Selecting a link 130 triggers an external actor, such as opening an application, accessing a clinical system, populating data, and/or producing an output, for example. A user may select a plurality of links 130 for the workflow within a single user interface 100, thus avoiding multiple logins for multiple systems, use of a plurality of interfaces to execute a single workflow, etc. Additionally, multiple users may be given access to the task list 110 via the interface 100 such that different users may execute different actions 130 within the workflow. In certain embodiments, links 130 to already-executed tasks may be represented differently from links 130 to not-yet-executed tasks such that a user may visually discern which actions 130 have been executed and which have not. In certain embodiments, multiple users may simultaneously execute tasks 130 via the interface 100 from different workstations. In other embodiments, multiple users may access the interface 100 in sequence, with actions taken by prior users stored for reference by later users, for example.

In certain embodiments, “to do” or task lists, decision support options and feedback, and workflow output may be presented via the user interface 100, for example. A variety of information from a variety of sources may be centralized for a user via the interface 100, for example. In certain embodiments, state information for the interface 100 such that it is available for later retrieval and use. In certain embodiments, patient electronic medical record information may be modified via the interface 100, for example.

In certain embodiments, instead of and/or in addition to display of data and links in a chart-based format, information may be displayed in a tabular or column-based format, a timeline or chronological format integrated and/or separated based on category/type of information, etc., for example. The interface 100 may provide a browser or other interface having an ability to search and filter a patient's full electronic medical record so as to visualize a full context to a patient's health or pathology, for example. In certain embodiments, a single or unified display system that allows the display of a patient's complete electronic medical record at one time.

Certain embodiments allow a user to visualize patient medical data from a single workstation and/or interface without having to log in to multiple workstations. For example, data is automatically retrieved and aggregated in advance and/or on request through communication with a plurality of underlying systems for display via a single interface. Having all the data accessible at one time also allows a user to display and visualize the data in a variety of informative layouts.

In certain embodiments, users may view patient and/or workflow information at a high level to provide an overall view. From a high level overall vantage point, the user may navigate to any specific item on the patient's history by using a navigational cursor, mouse click, touch screen, voice command, gaze tracking, etc. The user can drill down to retrieve and/or otherwise view more detailed and/or specific information, for example.

In certain embodiments, comprehensive patient data points may be aggregated into a single location (e.g., a thumbdrive, CD, DVD, hard drive, etc.). Export capability from a plurality of clinical applications allows aggregation and storage of information to a single locale. In certain embodiments, a patient medical record may include aggregated information from a plurality of information systems under a common patient context. Information systems may include a radiology information system (RIS), a picture archiving and communication system (PACS), Computer Physician Order Entry (CPOE), an electronic medical record (EMR), Clinical Information System (CIS), Cardiovascular Information System (CVIS), Library Information System (LIS), and/or other healthcare information system (HIS), for example. An interface facilitating access to the patient record may include a context manager, such as a clinical context object workgroup (CCOW) context manager and/or other rules-based context manager. Components may communicate via wired and/or wireless connections on one or more processing units, such as computers, medical systems, storage devices, custom processors, and/or other processing units. Components may be implemented separately and/or integrated in various forms in hardware, software and/or firmware, for example.

Certain embodiments may be used to provide an integrated solution for application execution and/or information retrieval based on rules and context sharing, for example. For example, context sharing allows information and/or configuration options/settings, for example, to be shared between system environments. Rules, for example, may be defined dynamically and/or loaded from a library to filter and/or process information generated from an information system and/or an application.

Information for a particular patient may be extracted and/or linked from one or more information systems for presentation to a user via a unified patient interface, for example. In certain embodiments, information retrieval, display and/or processing settings, for example, may be customized according to a particular user or type of user. Retrieval, aggregation, display and/or processing of information may be based on rules, preferences, and/or other settings, for example. Rules, preferences, settings, etc. may be generated automatically based on preset parameters and/or observed data, for example. Rules, preferences, settings, etc., may be created by a system administrator or other user, for example. Rules, preferences, settings, etc., also may be manually and/or automatically adapted based on experiences, for example.

In certain embodiments, a user may log on any one of the connected systems and/or a separate system to access information found on all of the connected systems through context sharing and a unified user interface. In certain embodiments, information may be filtered for easier, more effective viewing.

In certain embodiments, a user interface providing a patient record may work together with a perspectives management system for handling multiple applications and workflow, for example. The perspectives management system allows various perspectives to be defmed which save workflow steps and other information for a particular user. Perspectives may be used to save visual component positioning information and interactions based on workflow, for example. Perspectives allow relevant information to be presented to a user.

In certain embodiments, a patient record provides identification information, allergy and/or ailment information, history information, orders, medications, progress notes, flowsheets, labs, images, monitors, summary, administrative information, and/or other information, for example. The patient record may include a list of tasks for a healthcare practitioner and/or the patient, for example. The patient record may also identify a care provider and/or a location of the patient, for example.

In certain embodiments, an indication may be given of, for example, normal results, abnormal results, and/or critical results. For example, the indication may be graphical, such as an icon. The user may select the indicator to obtain more information. For example, the user may click on an icon to see details as to why a result was abnormal. The user may be able to view only certain types of results. For example, the user may view only critical results. Similarly, actions or tasks having varying degrees of importance may be represented using different indications. Actions or tasks having varying degrees of completion may also be represented using different indications, for example.

In certain embodiments, a unified user interface is in communication with one or more applications and/or information systems, for example. The unified user interface interacts with individual interfaces for the application(s) and/or system(s) and masks or hides the individual interfaces from a user. That is, the user sees and interacts with the unified user interface rather than the underlying individual interfaces. A user may be authenticated at the unified user interface. Authentication at the unified user interface may propagate through the connected application(s) and/or system(s), for example.

In certain embodiments, an interface including patient information and tasks may be viewed and/or constructed using a system such as system 200 including at least one data storage 210 and at least one workstation 220. While three workstations 220 are illustrated in system 200, a larger or smaller number of workstations 220 can be used in accordance with embodiments of the presently described technology. In addition, while one data storage 210 is illustrated in system 200, system 200 can include more than one data storage 210. For example, each of a plurality of entities (such as remote data storage facilities, hospitals or clinics) can each include one or more data stores 210 in communication with one or more workstations 220.

As illustrated in system 200, one or more workstations 220 can be in communication with at least one other workstation 220 and/or at least one data storage 210. Workstations 220 can be located in a single physical location or in a plurality of locations. Workstations 220 can be connected to and communicate via one or more networks.

Workstations 220 can be directly attached to one or more data stores 210 and/or communicate with data storage 210 via one or more networks. Each workstation 220 can be implemented using a specialized or general-purpose computer executing a computer program for carrying out the processes described herein. Workstations 220 can be personal computers or host attached terminals, for example. If workstations 220 are personal computers, the processing described herein can be shared by one or more data stores 210 and a workstation 220 by providing an applet to workstation 220, for example.

Workstations 220 include an input device 222, an output device 224 and a storage medium 226. For example, workstations 220 can include a mouse, stylus, microphone and/or keyboard as an input device. Workstations 220 can include a computer monitor, liquid crystal display (“LCD”) screen, printer and/or speaker as an output device.

Storage medium 226 of workstations 220 is a computer-readable memory. For example, storage medium 226 can include a computer hard drive, a compact disc (“CD”) drive, a USB thumb drive, or any other type of memory capable of storing one or more computer software applications. Storage medium 226 can be included in workstations 220 or physically remote from workstations 220. For example, storage medium 226 can be accessible by workstations 220 through a wired or wireless network connection.

Storage medium 226 includes a set of instructions for a computer. The set of instructions includes one or more routines capable of being run or performed by workstations 220. The set of instructions can be embodied in one or more software applications or in computer code.

Data storage 210 can be implemented using a variety of devices for storing electronic information such as a file transfer protocol (“FTP”) server, for example. Data storage 210 includes electronic data. For example, data storage 210 can store EMRs for a plurality of patients. Data storage 210 may include and/or be in communication with one or more clinical information systems, for example.

Communication between workstations 220, workstations 220 and data storage 210, and/or a plurality of data stores 210 can be via any one or more types of known networks including a local area network (“LAN”), a wide area network (“WAN”), an intranet, or a global network (for example, Internet). Any two of workstations 220 and data stores 210 can be coupled to one another through multiple networks (for example, intranet and Internet) so that not all components of system 200 are required to be coupled to one another through the same network.

Any workstations 220 and/or data stores 210 can be connected to a network or one another in a wired or wireless fashion. In an example embodiment, workstations 220 and data store 210 communicate via the Internet and each workstation 220 executes a user interface application to directly connect to data store 210. In another embodiment, workstation 220 can execute a web browser to contact data store 210. Alternatively, workstation 220 can be implemented using a device programmed primarily for accessing data store 210.

Data storage 210 can be implemented using a server operating in response to a computer program stored in a storage medium accessible by the server. Data storage 210 can operate as a network server (often referred to as a web server) to communicate with workstations 220. Data storage 210 can handle sending and receiving information to and from workstations 220 and can perform associated tasks. Data storage 210 can also include a firewall to prevent unauthorized access and enforce any limitations on authorized access. For instance, an administrator can have access to the entire system and have authority to modify portions of system 200 and a staff member can only have access to view a subset of the data stored at data store 210. In an example embodiment, the administrator has the ability to add new users, delete users and edit user privileges. The firewall can be implemented using conventional hardware and/or software.

Data store 210 can also operate as an application server. Data store 210 can execute one or more application programs to provide access to the data repository located on data store 210. Processing can be shared by data store 210 and workstations 220 by providing an application (for example, a java applet). Alternatively, data store 210 can include a stand-alone software application for performing a portion of the processing described herein. It is to be understood that separate servers may be used to implement the network server functions and the application server functions. Alternatively, the network server, firewall and the application server can be implemented by a single server executing computer programs to perform the requisite functions.

The storage device located at data storage 210 can be implemented using a variety of devices for storing electronic information such as an FTP server. It is understood that the storage device can be implemented using memory contained in data store 210 or it may be a separate physical device. The storage device can include a variety of information including a data warehouse containing data such as patient medical data, for example.

Data storage 210 can also operate as a database server and coordinate access to application data including data stored on the storage device. Data storage 210 can be physically stored as a single database with access restricted based on user characteristics or it can be physically stored in a variety of databases.

In an embodiment, data storage 210 is configured to store data that is recorded with or associated with a time and/or date stamp. For example, a data entry can be stored in data storage 210 along with a time and/or date at which the data was entered or recorded initially or at data storage 210. The time/date information can be recorded along with the data as, for example, metadata. Alternatively, the time/date information can be recorded in the data in manner similar to the remainder of the data. In another alternative, the time/date information can be stored in a relational database or table and associated with the data via the database or table.

In an embodiment, data storage 210 is configured to store medical data for a patient in an EMR. The medical data can include data such as numbers and text. The medical data can also include information describing medical events. For example, the medical data/events can include a name of a medical test performed on a patient. The medical data/events can also include the result(s) of a medical test performed on a patient. For example, the actual numerical result of a medical test can be stored as a result of a medical test. In another example, the result of a medical test can include a finding or analysis by a caregiver that entered as text.

In operation, a user employs a workstation 220 to display, on an output device 224, a patient chart and/or other interface aggregated from data and/or functionality stored at one or more data storage 210. The workstation 220 facilitates filtering/search of the available data and provision of one or more associations among a plurality of the data and/or events visually represented to the user, for example. As described above, workstation 220 includes computer-readable storage medium 226 that itself comprises a set of instructions for workstation 220. The set of instructions can be embodied in one or more computer software applications or computer code. This set of instructions is used by workstation 220 to access and display data and/or events and one or more associations among a plurality of the data/events. Thus, at least one technical effect of the set of instructions is to aggregate and provide data and functionality from one or more clinical systems so as to enable a user to more quickly and easily execute tasks in a workflow and review patient electronic medical record data, for example.

The set of instructions includes one or more software routines. In certain embodiments, the set of instructions includes a workflow processing routine configured to associate tasks in a clinical workflow with external actors. The set of instructions also includes a user interface routine displaying clinical information to a user. The tasks are represented as links in the user interface. Each of the links triggers access to a corresponding external actor. Selection of at least one of the task links via the user interface triggers at least one of execution of and access to at least one of the external actors.

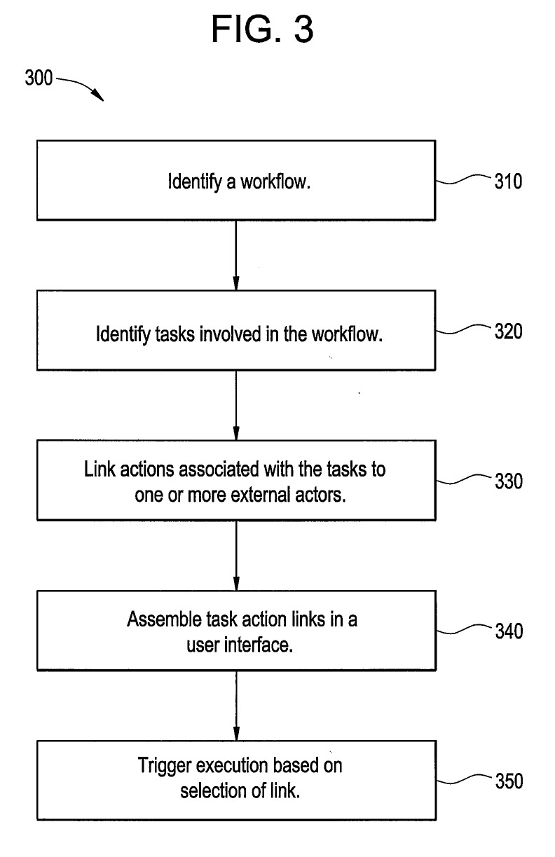

FIG. 3 illustrates a flow diagram for a method 300 for providing a workflow task list and other information for selection by a user via a user interface in accordance with an embodiment of the present invention. At step 310, a workflow is identified. For example, a patient discharge workflow is identified. At step 320, tasks involved in the workflow are identified. For example, patient education, documentation, prescription, and reminder tasks in the patient discharge workflow are identified.

At step 330, actions associated with tasks in the workflow are linked with one or more external actors. External actors may include an application, a part of an application, data, a clinical system, etc. For example, callback reminder options may be associated with a scheduler application to schedule a patient callback reminder after a certain time interval. Documentation tasks may be associated with patient and/or practice data for display and/or other output, for example. Prescription tasks may be associated with an order entry application for filling of a prescription, for example.

At step 340, task action links are assembled in a user interface. For example, task action links may be assembled in a clinical system user interface in conjunction with patient chart information as illustrated in the exemplary interface 100 of FIG. 1. At step 350, selection of task action links by a user triggers execution, access, and/or retrieve of application(s), data and/or clinical system(s), for example. For example, selection of a pain management link on the interface takes the user, via the interface, to documentation regarding pain management for output to a discharged patient.

One or more of the steps of the method 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more embodiments of the presently described invention provide several advantages. In certain embodiments, information can be aggregated from a variety of sources and present to the user in a unified format. In certain embodiments, information may be searched and/or filtered based on one or more criteria. In addition, using embodiments of the presently described technology, relevant information can be accessed without the uncertainty of accessing unrelated data/events that occur in close proximity to related data/events.

Certain embodiments provide improved productivity of a clinical user by facilitating easier and faster navigation of clinical applications and data and tracking of task status to indicate tasks that have been completed by another individual. Certain embodiments help reduce training costs for a customer in rolling out an application to new users through an easy-to-use task list interface system. Certain embodiments help provide improved patient safety and clinical outcomes due to incorporation of a user interface element that aggregates ‘decision support’ features with other ‘to do’ features. This allows the clinical user an opportunity to see what tasks are recommended for a patient. Decision support systems that are decoupled from the user interface may not be as likely to present output to the user in a meaningful way.

As opposed to other software systems offering task lists and workflows to users, certain embodiments provide task list links, computational workflow rules, and clinical decision support logic in a clinical application such that the output is presented to the user in a consistent, accessible, and aggregated manner and such that the user can act on the output via tight integration with the navigation structure of the clinical system.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS workstation or one or more dedicated processors.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any clinical system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A clinical application system facilitating completion of clinical workflow tasks, said system comprising:
a processor configured to associate tasks in a clinical workflow with external actors; and
a user interface displaying clinical information to a user, said tasks represented as links in said user interface, each of said links triggering access to a corresponding external actor,
wherein selection of at least one of said task links via said user interface triggers at least one of execution of and access to at least one of said external actors.

2. The system of claim 1, wherein said processor automatically facilitates login for one or more of said external actors without user intervention.

3. The system of claim 1, further comprising an input allowing a user to edit patient data and workflow information via said user interface.

4. The system of claim 1, wherein said external actors comprise one or more of an application, a part of an application, data, and a clinical system.

5. The system of claim 1, wherein said user interface displays said task links in conjunction with information for a patient.

6. The system of claim 1, wherein said user interface displays said task links grouped into subcategories.

7. The system of claim 1, wherein said user interface allows a user to select a workflow for execution with respect to a patient, said selected workflow triggering an association of tasks to external actors.

8. The system of claim 1, wherein said user interface visually indicates completed tasks and uncompleted tasks.

9. The system of claim 1, wherein said processor, in conjunction with said user interface, allow multiple users to select and execute workflow task links via one or more instantiations of said user interface.

10. A method for workflow task execution via a clinical application interface, said method comprising:
associating tasks in a clinical workflow with external actors, said tasks represented as links in said clinical application interface, each of said links triggering access to a corresponding external actor;
displaying said task links to a user via said clinical application interface; and
triggering at least one of execution of and access to at least one of said external actors through selection of at least one of said task links via said clinical application interface.

11. The method of claim 10, wherein said external actors comprise one or more of an application, a part of an application, data, and a clinical system.

12. The method of claim 10, wherein said displaying step further comprises displaying said task links in conjunction with information for a patient via said clinical application interface.

13. The method of claim 10, further comprising grouping tasks into subcategories for display via said clinical application interface.

14. The method of claim 10, further comprising selecting a workflow for execution with respect to a patient, said selected workflow triggering said associating step to associate tasks with external actors.

15. The method of claim 10, further comprising modifying patient information via said clinical application interface.

16. The method of claim 10, further comprising visually indicating completion of a task via said clinical application interface.

17. The method of claim 10, further comprising facilitating interaction of multiple users in selecting and executing workflow task links via one or more instantiations of said user interface.

18. A computer readable medium having a set of instructions for execution on a computer, said set of instructions comprising:
a workflow processing routine configured to associate tasks in a clinical workflow with external actors; and
a user interface routine displaying clinical information to a user, said tasks represented as links in said user interface, each of said links triggering access to a corresponding external actor, wherein selection of at least one of said task links via said user interface triggers at least one of execution of and access to at least one of said external actors.

19. The computer readable medium of claim 18, wherein said external actors comprise one or more of an application, a part of an application, data, and a clinical system.

20. The computer readable medium of claim 18, wherein said user interface routine visually indicates completion of a task.

21. The computer readable medium of claim 18, wherein said workflow processing routine, in conjunction with said user interface routine, facilitate interaction of multiple users in selecting and executing workflow task links via one or more instantiations of said user interface.
